(19) United States
(12) Patent Application Publication
(10) Pub. No.: US 2021/0356895 A1
(43) Pub. Date: Nov. 18, 2021

(54) IMAGE FORMING APPARATUS

(71) Applicant: Ricoh Company, Ltd., Tokyo (JP)

(72) Inventor: Hiroki YAMAMURA, Tokyo (JP)

(73) Assignee: Ricoh Company, Ltd., Tokyo (JP)

(21) Appl. No.: 17/318,374

(22) Filed: May 12, 2021

(30) Foreign Application Priority Data
May 18, 2020 (JP) 2020-086557

(51) Int. Cl. G03G 15/00

(52) U.S. Cl. CPC G03G 15/5062; G03G 2215/00067; G03G 15/5016

(57) ABSTRACT

An image forming apparatus includes an image forming device and control circuitry to control the image forming device. The control circuitry is configured to: select control content to be executed based on a selection instruction from a user; set a set time of executing control of the control content selected, based on a setting instruction from the user; and execute, at the set time, the control of the control content selected.

### CROSS-REFERENCE TO RELATED APPLICATION

This patent application is based on and claims priority pursuant to 35 U.S.C. § 119(a) to Japanese Patent Application No. 2020-086557, filed on May 18, 2020, in the Japan Patent Office, the entire disclosure of which is hereby incorporated by reference herein.

### BACKGROUND

### Technical Field

Embodiments of the present disclosure relate to an image forming apparatus.

### Related Art

Image forming apparatuses are known that include an image forming unit and a control unit to control the image forming unit.

For example, an image forming apparatus is known that includes a control unit to automatically adjust image forming conditions of an image forming unit. The image forming apparatus can set any start time of automatic adjustment. When the time by a clock unit reaches the set time, the control unit starts the automatic adjustment of the image forming condition.

### SUMMARY

According to an aspect of the present disclosure, there is provided an image forming apparatus that includes an image forming device and control circuitry to control the image forming device. The control circuitry is configured to: select control content to be executed based on a selection instruction from a user; set a set time of executing control of the control content selected, based on a setting instruction from the user; and execute, at the set time, the control of the control content selected.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating a hardware configuration related to control of an image forming apparatus according to an embodiment of the present disclosure;

FIG. 2 is a schematic diagram illustrating a hardware configuration of a printer engine in the image forming apparatus of FIG. 1;

FIG. 3 is a functional block diagram relating to image quality adjustment control according to an embodiment of the present disclosure;

FIG. 4 is an illustration of an example of an operation screen displayed on an operation panel of the image forming apparatus of FIG. 1;

FIG. 5 is an illustration of an example of an adjustment item screen displayed on the operation panel;

FIG. 6A is an illustration of an example of a reservation date and time setting screen displayed on the operation panel;

FIG. 6B is an illustration of an example of an operation setting screen displayed on the operation panel;

FIG. 7A is an illustration of an example of a status display screen of adjustment reservation displayed on the operation panel after a “completion” key is touched on the operation setting screen;

FIG. 7B is an illustration of an example of an execution result display screen of adjustment reservation displayed on the operation panel after all reserved control operations are completed;

FIG. 8 is a flowchart of a flow of processing in executing a reserved control operation;

FIG. 9A is a schematic diagram illustrating an example of a black toner adhesion amount sensor;

FIG. 9B is a schematic diagram illustrating an example of a color toner adhesion amount sensor;

FIG. 10 is a functional block diagram of an image quality adjustment unit in an image quality adjustment control example 1; and

FIGS. 11A, 11B, and 11C are illustrations of examples of correction patterns formed on an intermediate transfer belt, which are used for image quality adjustment controls;

FIG. 12 is a perspective view illustrating an example of an image density sensor;

FIG. 13A is a cross-sectional view of the image density sensor of FIG. 12 taken along a cross section orthogonal to a main scanning direction;

FIG. 13B is a schematic configuration diagram of an image element included in the image density sensor of FIG. 12;

FIG. 14 is a functional block diagram of an image quality adjustment unit in an image quality adjustment control example 2; and

FIGS. 15A, 15B, 15C, and 15D are illustrations of examples of correction patterns formed on a sheet, which are used for image quality adjustment controls.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

With reference to drawings, descriptions are given below of embodiments of the present disclosure. It is to be noted that elements (for example, mechanical parts and components) having the same functions and shapes are denoted by the same reference numerals throughout the specification and redundant descriptions are omitted.

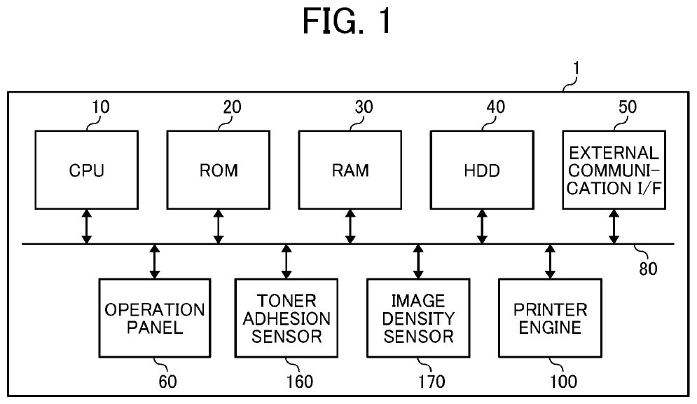

Below, a description is given of an image forming apparatus according to an embodiment of the present disclosure. FIG. 1 is a block diagram illustrating a hardware configuration related to control of an image forming apparatus according to an embodiment of the present disclosure. As illustrated in FIG. 1, the image forming apparatus 1 according to the present embodiment includes a central processing unit (CPU) 10, a read only memory (ROM) 20, a random access memory (RAM) 30, a hard disk drive (HDD) 40, an external communication interface (I/F) 50, an operation panel 60, a printer engine 100, a toner adhesion amount sensor 160, and an image density sensor 170. A system bus 80 interconnects the above-described elements.

The CPU 10 controls operations of the image forming apparatus 1. Specifically, the CPU 10 executes programs stored in the ROM 20 or the HDD 40, using the RAM 30 as a work area to control the operations of the entire image forming apparatus 1 and implement various functions, such as copying, scanning, faxing, and printing. The CPU 10 also functions as an image quality adjustment unit that performs image quality adjustment control of an image to be formed by executing a program stored in the ROM 20 or the HDD 40.

The ROM 20 is a nonvolatile semiconductor memory that can retain data even when a power source is turned off. The RANI 30 is a volatile semiconductor memory that temporarily stores a program or data. The HDD 40 is a nonvolatile memory that stores programs or data. Programs and data stored in the HDD 40 include an operating system (OS), which is basic software for controlling the entire image forming apparatus 1, various application programs operating on the OS, and operation conditions of various functions such as the copy function, the scanner function, the facsimile function, and the printer function mentioned above. The HDD 40 can further store operations of such various functions (hereinafter also “jobs”), including operations of the image forming apparatus 1 and so on, each time each job is executed.

The external communication I/F 50 is an interface to connect the image forming apparatus 1 to a network, such as the Internet or a local area network (LAN). The image forming apparatus 1 can receive a print instruction, image data, and the like from external devices via the external communication I/F 50.

The operation panel 60 serves as an input receiving device to receive various types of input according to the user's operation and displays various types of information (for example, information indicating the received operation, information indicating the operation status of the image forming apparatus 1, or information indicating the setting status of the image forming apparatus 1). In one example, the operation panel 60 is, but not limited to, a liquid crystal display (LCD) having a touch panel function. For another example, the operation panel 60 may include an organic electroluminescence (EL) display functioning as the touch panel. In addition to or instead of the above-described operation panel 60, an operation device such as a hardware key or a display device such as a lamp may be provided. The operation panel 60 is controlled by the CPU 10.

A printer engine 100 as an image forming device is hardware for realizing a printer function, a copy function, a facsimile function, and the like, and functions as an image forming device that forms an image on a sheet as a recording material. As the printer function, an electrophotographic method, an inkjet method, or the like can be applied, but the printer function is not limited thereto. The printer engine 100 may further include an optional device, such as a finisher that sorts printed sheets or such as an automatic document feeder (ADF) that automatically feeds an original document. The printer engine 100 is controlled by the CPU 10.

The image forming apparatus 1 may also include an external interface to read and write an external storage medium, such as a compact disc (CD), a digital versatile disc (DVD), a secure digital (SD) memory card, or a universal serial bus (USB) memory, via the external interface.

The programs stored in the ROM 20 or the HDD 40 can be processed by a computer. The programs may be installed in the ROM 20 or the HDD 40 at the time of manufacture or shipment of the image forming apparatus 1 or may be installed after sale. As a method of installing programs after sale, for example, the programs can be installed via an external storage medium drive using an external storage medium storing the programs or via a network using the external communication I/F 50.

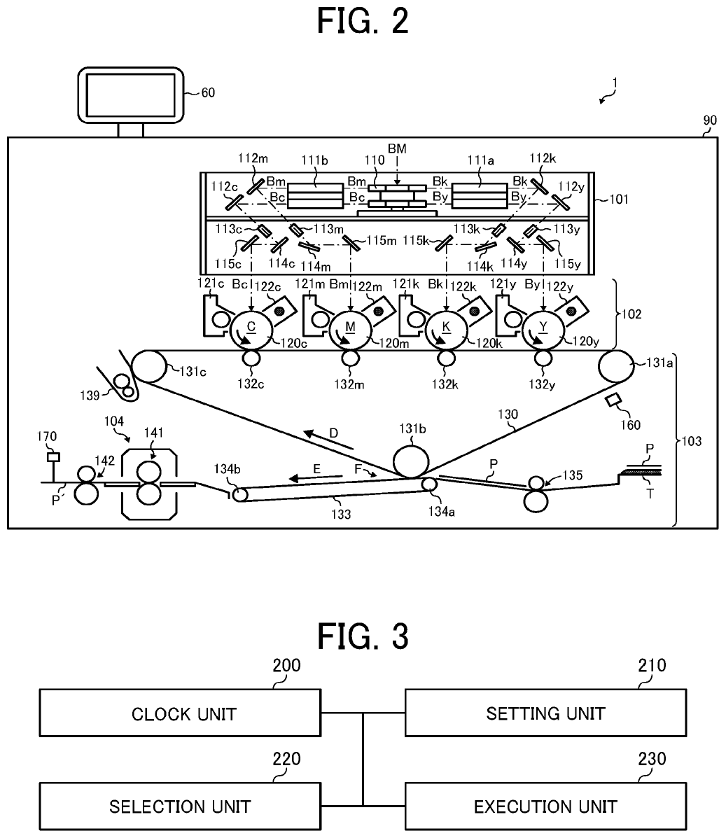

FIG. 2 is a schematic view illustrating a hardware configuration of the printer engine 100. The printer engine 100 is disposed inside a housing 90 of the image forming apparatus 1 and includes an exposure device 101, an image forming unit 102, a transfer device 103, and a fixing device 104. The operation panel 60 is disposed on the housing 90.

The image forming unit 102 includes a photoconductor 120y for yellow (Y), a photoconductor 120k for black (K), a photoconductor 120m for magenta (M), and photoconductor 120c for a cyan (C), each of which is an image bearer. The image forming unit 102 further includes a developing device 121y, a developing device 121k, a developing device 121m, and a developing device 121c for yellow, black, magenta, and cyan, respectively. The image forming unit 102 further includes a charger 122y for yellow (Y), a charger 122k for black (K), a charger 122m for magenta (M), and a charger 122c for cyan (C) as charging devices.

The transfer device 103 includes an intermediate transfer belt 130 as an intermediate transferor, which is an image bearer, and a secondary transfer belt 133. The fixing device 104 includes a fixing member 141, an ejection roller 142, and the like.

Hereinafter, a function of forming an image on a sheet as a recording material based on image data is described as an example of functions of the printer engine 100 as an image forming device with reference to FIG. 2.

The exposure device 101 emits writing light for writing latent images corresponding to image data on the photoconductors 120y, 120k, 120m, and 120c of the image forming unit 102 and exposes the photoconductors 120y, 120k, 120m, and 120c (hereinafter, also collectively referred to as “photoconductors 120y to 120c”). That is, the light beam is selectively emitted at a writing position corresponding to an image pattern of the image data and at a writing light amount corresponding to the image density. Light from a laser light source or a light emitting diode (LED) light source can be used as the writing light. The following description is provided of an example using a laser light source including a laser diode (LD).

First, a light beam BM emitted from a laser light source is deflected by a polygon mirror 110 and enters scanning lenses 111a and 111b each including an fθ lens. The light beams are generated corresponding to images of respective colors of yellow (Y), black (K), magenta (M), and cyan (C) in number and reflected by reflection mirrors 112y, 112k, 112m, and 112c (hereinafter, also collectively referred to as “reflection mirrors 112y to 112c”) after passing through the scanning lenses 111a and 111b. For example, a yellow light beam By permeates through the scanning lens 111a, is reflected by the reflection mirror 112y, and enters a wide toroidal lens (WTL) lens 113y. A black light beam Bk, a magenta light beam Bm, and a cyan light beam Bc are guided in a similar manner, and redundant descriptions are omitted.

WTL lenses 113y, 113k, 113m, and 113c shape the incident light beams By, Bk, Bm, and Bc (hereinafter, also collectively referred to as “the light beams By to Bc”), respectively, and then deflect the light beams By to Bc to the reflection mirrors 114y, 114k, 114m, and 114c (hereinafter, also collectively referred to as “reflection mirrors 114y to 114c”). Then, the light beams By, Bk, Bm, and Bc are further reflected by the reflection mirrors 115y, 115k, 115m, and 115c (hereinafter, also collectively referred to as “reflection mirrors 115y to 115c”), and are irradiated onto the photoconductors 120y to 120c as the light beams By to Bc used for exposure.

The irradiation of the light beams By to Bc onto the photoconductors 120y to 120c is synchronized in timing with respect to the main-scanning direction and the sub-scanning direction on the photoconductors 120y to 120c. In addition, the photoconductor is, for example, shaped like a drum that is long in the main scanning direction and may be referred to as a photoconductor drum.

Hereinafter, the main-scanning direction on the photoconductors 120y to 120c is defined as the scanning direction of the light beams By to Bc, and the sub-scanning direction is defined as the direction orthogonal to the main-scanning direction, that is, the direction of rotation of the photoconductors 120y to 120c.

The photoconductors 120y to 120c include a photoconductive layer including at least a charge generation layer and a charge transport layer on a conductive drum such as aluminum. The respective photoconductive layers of the photoconductors 120y to 120c and are charged by the chargers 122y to 122c, each of which includes a scorotron charger, a scorotron charger, a charging roller, or the like. Thus, the photoconductors 120y to 120c gain surface charges according to charging biases.

The photoconductors 120y to 120 given electrostatic charges by the chargers 122y to 122c are exposed by the light beams By to Bc as the writing light in accordance with the image pattern, and electrostatic latent images are formed on the surfaces scanned by the chargers 122y to 122c.

The electrostatic latent images respectively formed on the surfaces of the photoconductors 120y to 120c are developed by developing devices 121y to 121c to from toner images on scanned surface of the photoconductors 120y to 120c. Each of the developing devices 121y to 121c includes a developing roller to which a developing bias is applied, a toner supply roller, and a regulation blade.

The respective toner images carried on the photoconductors 120y to 120c are transferred onto the intermediate transfer belt 130 rotating in the direction indicated by arrow D by conveyance rollers 131a, 131b, and 131c. The toner images are superimposed one on another, forming a multicolor image. Primary transfer rollers 132y, 132k, 132m, and 132c (transfer devices) are disposed opposite the photoconductors 120y, 120k, 120m, and 120c, respectively. The intermediate transfer belt 130, onto which the yellow, black, magenta, and cyan toner images are transferred from scanned surfaces of the photoconductors 120y to 120c, is conveyed to a secondary transfer position F. The toner images are transferred from the scanned surfaces of the photoconductors 120y to 120c onto the intermediate transfer belt 130.

The secondary transfer belt 133 is wound around conveyance rollers 134a and 134b and conveyed in the direction indicated by arrow E by the conveyance rollers 134a and 134b. At the secondary transfer position F, a sheet P is fed from a sheet container T such as a sheet feeding tray by a conveyance roller 135. The sheet P is a recording medium, such as fine paper or a plastic sheet. At the secondary transfer position F, with application of a secondary transfer bias, a toner image borne on the intermediate transfer belt 130 is transferred onto the sheet P attracted and carried onto the secondary transfer belt 133. The sheet P is conveyed in the direction orthogonal to the main scanning direction.

As the secondary transfer belt 133 is conveyed, the sheet P is fed to the fixing device 104. The fixing device 104 includes the fixing member 141 such as a fixing roller including silicon rubber or fluoro-rubber. The toner image is fixed onto the sheet P under heat and pressure applied by the fixing device 104. Then, a sheet P′ bearing the multicolor toner image is ejected outside the fixing device 104 by the ejection roller 142.

After the toner image is transferred from the intermediate transfer belt 130, a cleaning device 139 including a cleaning blade removes residual toner from the intermediate transfer belt 130. Then, the intermediate transfer belt 130 is used in a next image forming process.

In the above-described operation of the printer engine 100, the direction of rotation of the photoconductors 120y to 120c, the direction of conveyance of the intermediate transfer belt 130, and the direction of conveyance of the sheet P and the sheet P′ (hereinafter referred to as “sheet conveyance direction”) are all orthogonal to the main-scanning direction and the same as the sub-scanning direction.

As described above, the printer engine 100 serving as an image forming device forms an image on a sheet based on image data.

Next, a description is given of image quality adjustment control for adjusting the image quality of an image formed by the printer engine 100.

FIG. 3 is a functional block diagram relating to image quality adjustment control in the present embodiment. The image forming apparatus 1 according to the present embodiment includes a clock unit 200, a setting unit 210, a selection unit 220, and an execution unit 230. The setting unit 210 sets a time at which the execution unit 230 as a control unit executes control of a selection selected by a selection unit 220 based on a user's setting instruction. The selection unit 220 selects a control to be executed by the execution unit 230 based on the user's selection instruction. The execution unit 230 executes control of the selection selected by the selection unit 220 when the time of the clock unit 200 reaches the time set by the setting unit 210.

The setting unit 210 and the selection unit 220 include, for example, an input receiving unit of the image forming apparatus 1. The input receiving unit is implemented by, for example, the operation panel 60. The input receiving unit performs functions of displaying information necessary for operation to a user and receiving various operations made by the user. The input receiving unit is also implemented by the processing of the external communication I/F 50 and performs a function of receiving instructions input by users from an external device via a local area network (LAN) or the Internet.

The setting unit 210 and the selection unit 220 include, for example, a display control unit of the image forming apparatus 1. The display control unit is implemented by the CPU 10 executing a program stored in the ROM 20 or the HDD 40, using the RAM 30 as the work area. The display control unit controls a display screen to be displayed on the operation panel 60.

The execution unit 230 is implemented by the CPU10 executing a program stored in the ROM 20 or the HDD 40, using the RAM 30 as a work area. The execution unit 230 executes a control operation for controlling each unit of the image forming apparatus 1. The execution unit 230 of the present embodiment includes an image formation control unit and an image quality adjustment unit. The image formation control unit executes a function of controlling the printer engine 100 as an image forming device. As an example, the image formation control unit can execute image formation under image formation conditions corresponding to the type of sheet included in a print instruction by the user. The image quality adjustment unit adjusts the image quality of an image formed by the image formation control unit in accordance with a command by a program (for example, automatic execution at a predetermined timing) or a command by a user's instruction input to the operation panel 60.

The execution unit 230 includes a storage unit. The storage unit is implemented by the ROM 20 or the HDD 40, and performs functions of storing programs, document data, image forming conditions and various setting information necessary for operations of the image forming apparatus 1, operation logs of the image forming apparatus 1, and the like. Examples of the image forming conditions include a charging bias, a developing bias, an optical writing light amount, and a transfer bias. The various types of information stored in the storage unit may be set before shipment of the image forming apparatus 1 or may be updated after shipment.

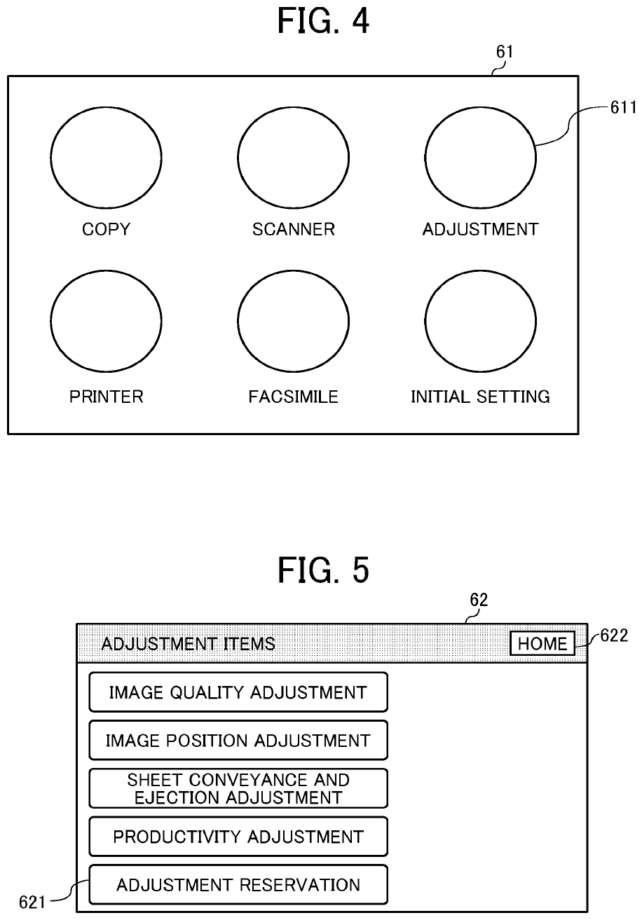

FIG. 4 is an illustration of an operation screen 61 displayed on the operation panel 60 of the image forming apparatus 1 according to the present embodiment. On the operation screen 61 displayed on the operation panel 60, icons for activating respective functions are displayed. The user can use an adjustment function by touching an “adjustment” icon 611.

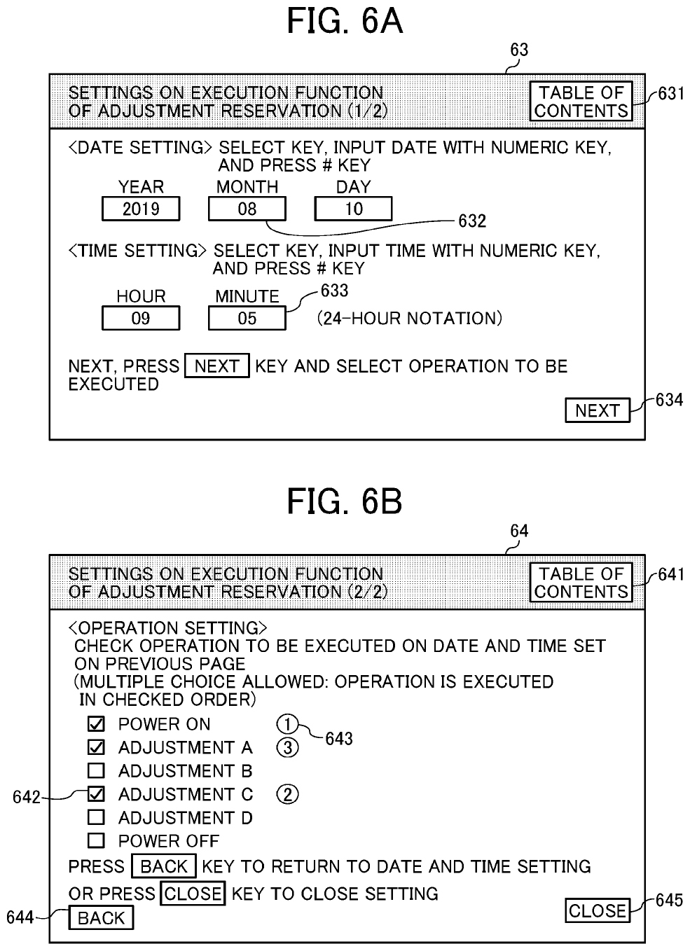

FIG. 5 is an illustration of an example of an adjustment item screen 62 displayed on the operation panel 60. When the “adjustment” icon 611 is touched on the operation screen 61 illustrated in FIG. 4, the display on the operation panel 60 transitions to an adjustment item screen 62 illustrated in FIG. 5. The items displayed on the adjustment item screen 62 are not limited to the items illustrated in FIG. 5. When an “adjustment reservation” icon 621 is touched on the adjustment item screen 62, the display on the operation panel 60 transitions to a reservation date and time setting screen 63 illustrated in FIG. 6A. When a “table of contents” key 631 is touched on the reservation date and time setting screen 63 illustrated in FIG. 6A, the display screen of the operation panel 60 returns to the previous adjustment item screen 62.

On the reservation date and time setting screen 63 illustrated in FIG. 6A, the user can perform a setting instruction operation of touching a “date setting” key 632 to set a date on which adjustment control of desired content is to be executed. Further, the user can perform a setting instruction operation of touching a “time setting” key 633 on the reservation date and time setting screen 63 to set the time at which the adjustment control of the desired content is to be executed. The user who has completed the date setting and the time setting in this way touches a “next” key 634 of the reservation date and time setting screen 63 to transition to the operation setting screen 64 illustrated in FIG. 6B. When the “table of contents” key 641 is touched on the operation setting screen 64 illustrated in FIG. 6B, the display screen of the operation panel 60 returns to the adjustment item screen 62.

In the operation setting screen 64 illustrated in FIG. 6B, control operations (for example, power ON, adjustments A to D, and power OFF) that can be executed by reservation are displayed together with check boxes 642. The user selects a control operation to be executed on the date and time set on the reservation date and time setting screen 63 illustrated in FIG. 6A from among the displayed control operations, and performs an operation of a selection instruction to touch and check a check box of the control operation. In this example, the operations are executed in the order in which the user has checked, and operation order symbols 643 are displayed on the operation setting screen 64 in the order in which the user has checked. When the “completion” key 645 is touched on the operation setting screen 64, the execution date and time and the control content to be executed are stored in the storage unit of the execution unit 230 of the image forming apparatus 1. When a “back” key 644 is touched on the operation setting screen 64, the display screen of the operation panel 60 returns to the previous reservation date and time setting screen 63.

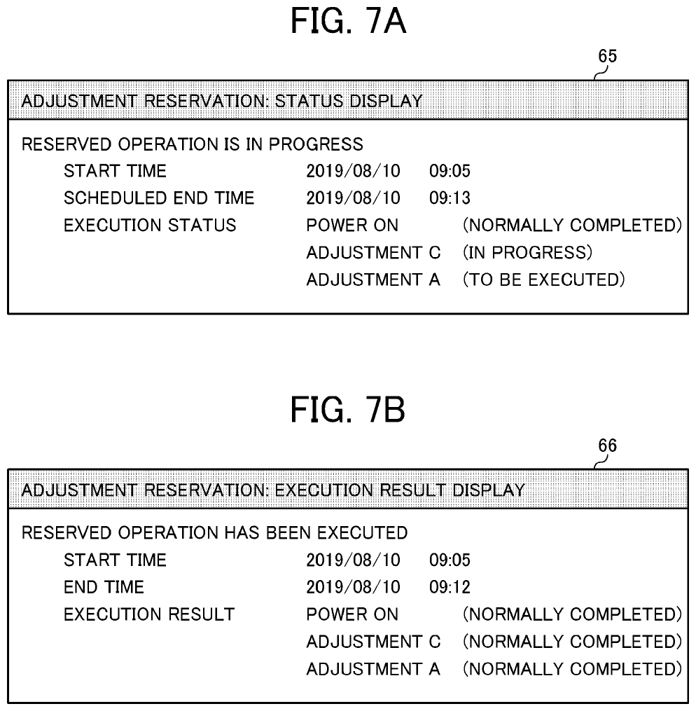

FIG. 7A is an illustration of an example of a status display screen 65 of adjustment reservation displayed on the operation panel 60 after the “completion” key 645 is touched on the operation setting screen 64. In the status display screen 65, “start time”, “scheduled end time”, and “execution status” are displayed. In the “execution status”, all the operations checked by the user in the operation setting screen 64 and statuses thereof are displayed.

FIG. 7B is an illustration of an example of an execution result display screen 66 of adjustment reservation displayed on the operation panel 60 after all reserved control operations are completed. In the execution result display screen 66, “start time” (time when the control is started), “end time” (time when the control is ended), and “execution result” are displayed. In the “execution result”, all operations (contents of executed control) checked by the user in the operation setting screen 64 and execution results (results of executed control) for the respective operations are displayed. Here, the case where all operations are normally completed is illustrated. However, when the image forming apparatus 1 detects an abnormality and interrupts the operation, an execution result such as “abnormal interruption” is displayed for the corresponding operation.

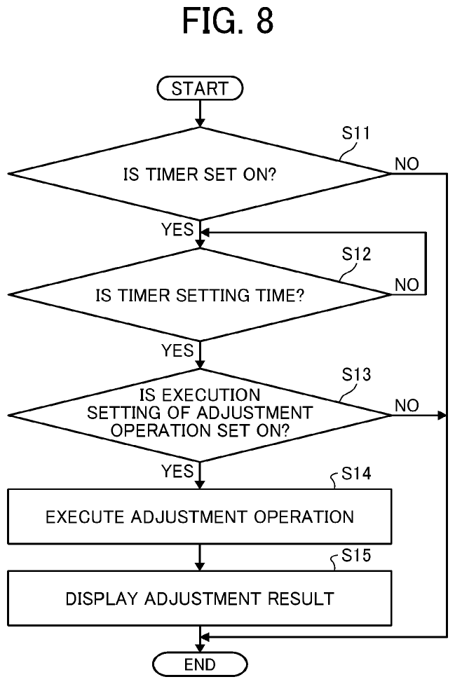

FIG. 8 is a flowchart of a flow of processing in executing a reserved control operation. First, the execution unit 230 checks whether a timer is set on, in other words, whether the date and time of executing a reserved control operation are stored in the storage unit (S11). If the timer is set off (No in S11), the process ends as it is.

If the timer is set on (YES in S11), the execution unit 230 determines whether the time of the clock unit 200 has reached the time set by the timer (the date and time stored in the storage unit) (S12). When the time of the clock unit 200 has reached the time set by the timer (YES in S12), the execution unit 230 checks whether the execution setting of adjustment operation is set on, that is, whether the control content to be executed is stored in the storage unit (S13). When the execution setting of adjustment operation (NO in S13), the process ends as it is.

If the execution setting of adjustment operation is set on (YES in S13), the execution unit 230 executes the set adjustment operation (S14). After the execution setting of adjustment operation is finished, the execution result display screen 66 illustrated in FIG. 7B is displayed on the operation panel 60 (S15) to notify a message indicating that the adjustment operation is finished and whether the adjustment operation is successful, and the process ends.

### Image Quality Adjustment Control Example 1

Next, an example of image quality adjustment control in the present embodiment (hereinafter referred to as “image quality adjustment control example 1”) will be described. As illustrated in FIG. 2, the image forming apparatus 1 according to the present embodiment includes a toner adhesion amount sensor 160 as a toner adhesion amount detector that detects the toner adhesion amount (toner image density) of a toner image formed on the outer peripheral surface of the intermediate transfer belt 130. The toner adhesion amount sensor 160 according to the present embodiment is an optical sensor unit including an optical sensor and the like. In the present embodiment, the toner adhesion amount sensor 160 is provided in the vicinity of the intermediate transfer belt 130. Toner images of predetermined image patterns formed on the photoconductors 120c, 120m, 120k, and 120y are transferred onto the intermediate transfer belt 130, and the toner adhesion amount sensor 160 detects the toner adhesion amounts (densities) of the toner images of the respective colors.

In the image quality adjustment control example 1, the image forming condition is determined based on the detection result of the toner adhesion amount (density) detected on the intermediate transfer belt 130. In the present embodiment, the toner adhesion amount sensor 160 is provided in the vicinity of the intermediate transfer belt 130. However, in some embodiments, the toner adhesion amount sensor 160 may be provided in the vicinity of each of the photoconductors 120c, 120m, 120k, and 120y or in the vicinity of the secondary transfer belt 133 to detect the toner adhesion amount of the toner image borne on each of the photoconductors 120c, 120m, 120k, and 120y.

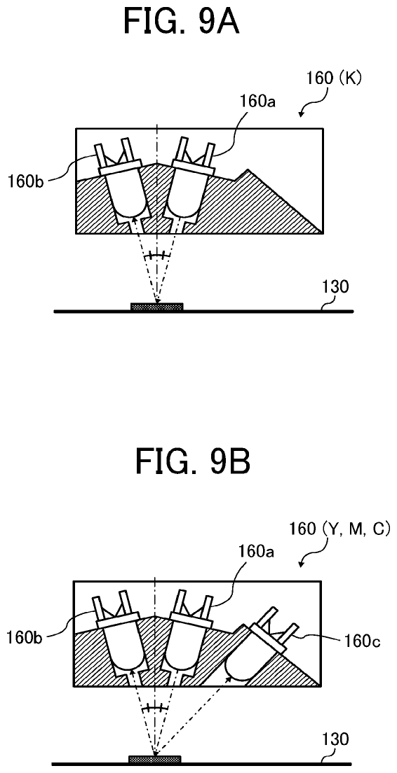

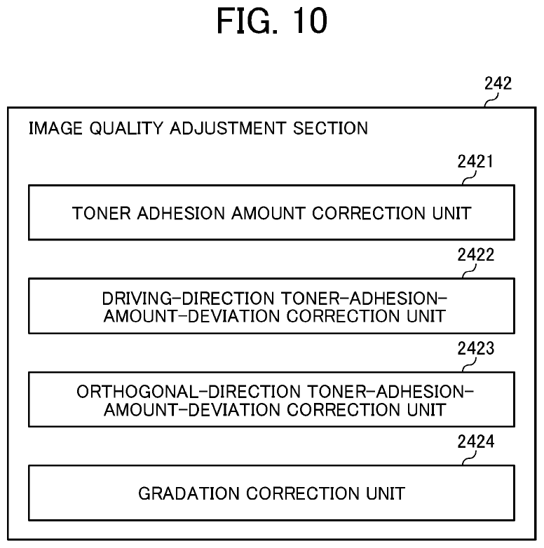

FIGS. 9A and 9B are schematic views illustrating examples of the toner adhesion amount sensor 160. FIG. 9A illustrates a black toner adhesion amount sensor 160 (K) suitable for detecting the toner adhesion amount (density) of a black toner image. FIG. 10B illustrates a color toner adhesion amount sensor 160 (Y, M, or C) suitable for detecting the toner adhesion amount (density) of a color toner image other than black.

The black toner adhesion amount sensor 160 (K) illustrated in FIG. 9A includes a light emitting element 160a formed of a light emitting diode (LED) or the like and a light receiving element 160b that receives specular reflection light. The light emitting element 160a emits light onto the intermediate transfer belt 130, and the emitted light is reflected by the surfaces of the intermediate transfer belt 130 and the toner. The light receiving element 160b receives specular reflection light among the reflection light.

The color toner adhesion amount sensor 160 (Y, M, or C) illustrated in FIG. 9B includes a light emitting element 160a formed of a light emitting diode (LED) or the like, a light receiving element 160b that receives specular reflection light, and a light receiving element 160c that receives diffuse reflection light. As in the case of the black toner adhesion amount sensor 160 (K), the light emitting element 160a emits light onto the intermediate transfer belt 130, and the emitted light is reflected by the surfaces of the intermediate transfer belt 130 and the toner. The light receiving element 160b receives specular reflection light among the reflection light, and the light receiving element 160c receives diffuse reflection light among the reflection light.

In the present embodiment, a GaAs infrared light emitting diode in which the peak wavelength of emitted light is 950 nm is used as the light emitting element, and a silicon phototransistor in which the peak light receiving sensitivity is 800 nm is used as the light receiving element. In some embodiments, the light emitting element and the light receiving element may have different peak wavelengths and peak light-receiving sensitivities. Each of the black toner adhesion amount sensor 160 (K) and the color toner adhesion amount sensors 160 (Y, M, and C) is disposed at a distance (detection distance) of, for example, about 5 mm from the belt surface of the intermediate transfer belt 130 on which a toner image as a detection target is borne.

Outputs from the black toner adhesion amount sensors 160 (K) and the color toner adhesion amount sensors 160 (Y, M, and C) are converted into toner adhesion amounts by an adhesion amount conversion algorithm. As the adhesion amount conversion algorithm, an algorithm similar to a conventional algorithm can be used.

FIG. 10 is a functional block diagram of the image quality adjustment unit 242 in the image quality adjustment control example 1. The image quality adjustment unit 242 of the image quality adjustment control example 1 includes a toner-adhesion-amount correction unit 2421, a driving-direction toner-adhesion-amount-deviation correction unit 2422, an orthogonal-direction toner-adhesion-amount-deviation correction unit 2423, and a gradation correction unit 2424. Some or all of these functions can be executed by user instructions from the operation panel 60.

When there is a difference between the target value of the toner adhesion amount and the actual toner adhesion amount, the toner-adhesion-amount correction unit 2421 executes control for correcting the difference in the toner adhesion amount. Specifically, the toner-adhesion-amount correction unit 2421 outputs a command for correcting the difference in the toner adhesion amount to the image formation control unit 241 based on the detection result of a toner-adhesion-amount correction pattern formed on the intermediate transfer belt 130 detected by the toner adhesion amount sensor 160. Examples of the command for correcting the difference in toner adhesion amount include, but are not limited to, a command for adjusting the toner concentration of the developer in the developing device, a command for adjusting the developing bias or the charging bias, a command for adjusting the writing light amount, and a command for displaying on the operation panel 60 that the difference in toner adhesion amount has occurred.

The driving-direction toner-adhesion-amount-deviation correction unit 2422 executes control for correcting the deviation in the toner adhesion amount (deviation of toner adhesion amount in the driving direction) when the deviation in the toner adhesion amount of a toner image formed on the intermediate transfer belt 130 occurs in the driving direction of the intermediate transfer belt 130 (movement direction of the surface of the intermediate transfer belt), that is, in the sub-scanning direction. Specifically, the driving-direction toner-adhesion-amount-deviation correction unit 2422 outputs a command for correcting the deviation in the toner adhesion amount in the driving direction to the image formation control unit 241 based on the detection result of the driving-direction toner-adhesion-amount-deviation correction pattern formed on the intermediate transfer belt 130 detected by the toner adhesion amount sensor 160.

Examples of the command for correcting the deviation in the toner adhesion amount in the driving direction includes, but are not limited to, a command for adjusting the toner concentration of the developer in the developing device (e.g., increasing the toner concentration in the developer so that the toner on the developing roller does not run short); a command for adjusting a developing bias or the charging bias (e.g., adjusting the developing bias or the charging bias so as to provide a developing potential that cancels the deviation); a command for adjusting the amount of writing light (e.g., controlling the amount of writing light so as to provide a developing potential that cancels the deviation); and a command for displaying on the operation panel 60 that there is a deviation in the toner adhesion amount in the driving direction.

The orthogonal-direction toner-adhesion-amount-deviation correction unit 2423 executes control for correcting the deviation in the toner adhesion amount (orthogonal-direction toner adhesion amount deviation) when the deviation in the toner adhesion amount of the image formed on the intermediate transfer belt 130 occurs in a direction (orthogonal direction) orthogonal to the driving direction of the intermediate transfer belt 130, that is, in the main scanning direction. Specifically, the orthogonal-direction toner-adhesion-amount-deviation correction unit 2423 outputs a command for correcting the orthogonal-direction toner adhesion amount deviation to the image formation control unit 241 based on an orthogonal-direction toner-adhesion-amount-deviation correction pattern formed on the intermediate transfer belt 130 detected by the toner adhesion amount sensor 160. Similar to the command for correcting the deviation of the toner adhesion amount in the driving direction, examples of the command for correcting the deviation of the toner adhesion amount in the orthogonal direction include, but are not limited to, a command for adjusting the toner concentration of the developer in the developing device, a command for adjusting the developing bias and the charging bias, a command for adjusting the writing light amount, and a command for displaying on the operation panel 60 that there is a deviation in the toner adhesion amount in the orthogonal direction.

When an abnormality occurs in the gradation of a toner image formed on the intermediate transfer belt 130, the gradation correction unit 2424 executes control for correcting the gradation. Specifically, the gradation correction unit 2424 outputs a command for correcting the gradation to the image formation control unit 241 based on the detection result of the gradation correction (calibration) pattern formed on the intermediate transfer belt 130 detected by the toner adhesion amount sensor 160. Examples of the command for correcting the gradation include, but are not limited to, a command for adjusting the toner concentration of the developer in the developing device, a command for adjusting the developing bias or the charging bias, a command for adjusting the amount of writing light, and a command for displaying the occurrence of the gradation abnormality on the operation panel 60.

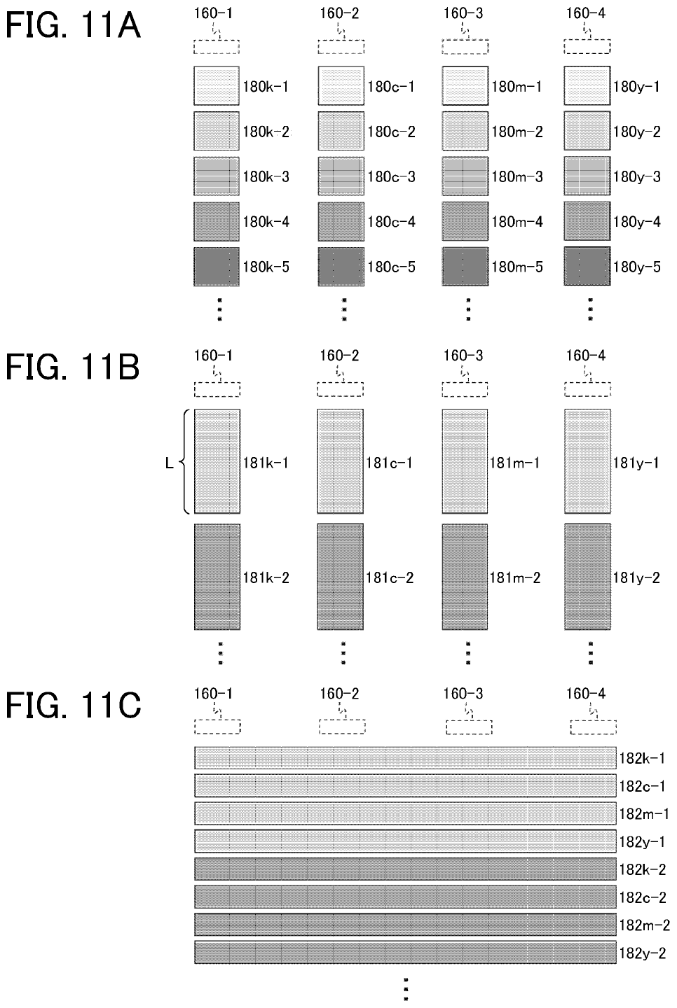

FIGS. 11A, 11B, and 11C are illustrations of examples of correction patterns formed on the intermediate transfer belt 130 and used for image quality adjustment controls. FIGS. 11A, 11B, and 11C, four toner adhesion amount sensors 160 are arranged in the main scanning direction. Note that the number and arrangement of the toner adhesion amount sensors 160 are not limited to the example illustrated in FIGS. 11A, 11B, and 11C.

As the toner-adhesion-amount correction pattern and the gradation correction pattern, for example, as illustrated in FIG. 11A, patterns in which gradation patches of K, C, M, and Y are formed in a stepwise manner can be used. FIG. 11A illustrates an example in which the patches of K, C, M, and Y are simultaneously formed with the same gradation. Note that the shape, number, layout, and the like of the formed patches are not limited thereto. The shape, gradation, and layout of patches may be different between the toner-adhesion-amount correction pattern and the gradation correction pattern.

As the driving-direction toner-adhesion-amount-deviation correction pattern, for example, as illustrated in FIG. 11B, a pattern can be used in which patches of K, C, M, and Y having long shapes in the driving direction are formed. The length of the patch is preferably longer than the circumferential length of the photoconductor, for example. FIG. 11B illustrates an example in which the patches of K, C, M, and Y are simultaneously formed with the same gradation. Note that the shape, layout, and the like of the formed patches are not limited thereto.

For example, as illustrated in FIG. 11C, a pattern in which patches of K, C, M, and Y having long shapes in the direction (orthogonal direction) orthogonal to the driving direction are formed can be used as the orthogonal-direction toner-adhesion-amount-deviation correction pattern. FIG. 11C illustrates an example in which the patches of K, C, M, and Y are formed with the same gradation. Note that the shape, layout, and the like of the formed patches are not limited thereto.

### Image Quality Adjustment Control Example 2

Next, a description is given of another example of the image quality adjustment control (hereinafter referred to as “image quality adjustment control example 2”). As illustrated in FIG. 2, the image forming apparatus 1 according to the present embodiment includes the image density sensor 170 as an image density detector that detects the image density on the sheet P′ discharged from the fixing device 104. The image density sensor 170 according to the present embodiment is an optical sensor unit that can detect image density for each color corresponding to a toner color and includes an optical sensor or the like. In the present embodiment, the toner adhesion amount sensor 160 is provided in the vicinity of the intermediate transfer belt 130. Toner images of predetermined image patterns formed on the photoconductors 120c, 120m, 120k, and 120y are transferred onto the intermediate transfer belt 130, and the toner adhesion amount sensor 160 detects the toner adhesion amounts (densities) of the toner images of the respective colors.

In the image quality adjustment control example 2, the image forming condition is determined based on the detection result of the image density detected on the sheet P′. The image density sensor 170 in the present embodiment is disposed downstream from the fixing device in the sheet conveyance direction. Note that, in some embodiments, the image density sensor 170 may be disposed near the intermediate transfer belt 130 or near the secondary transfer belt 133 on the upstream side of the fixing device in the sheet conveyance direction.

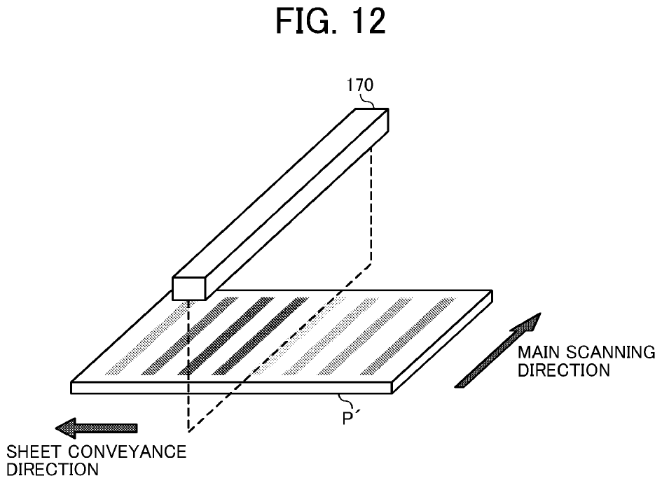

FIG. 12 is a perspective view illustrating an example of the image density sensor 170. As illustrated in FIG. 12, the image density sensor 170 is a line sensor elongated in the main scanning direction, and an image element elongated in the main scanning direction is provided inside the image density sensor 170. The detection width of the image density sensor 170 in the main scanning direction is a width indicated by a broken line in the main scanning direction in FIG. 12. The detection width is longer than the width of the sheet P′ in the main scanning direction. Accordingly, when the sheet P′ is conveyed so as to pass through the width indicated by the broken line in the main scanning direction, the image density can be detected over the entire area of the sheet P′. In other words, the image density sensor 170 in FIG. 12 can also detect the density of the right end portion, the left end portion, the leading end portion in the sheet conveyance direction, and the trailing end portion in the sheet conveyance direction of the sheet P′. FIG. 12 illustrates an example of the image density sensor 170 in which the detection width in the main scanning direction is longer than the width of the sheet P′ in the main scanning direction. Note that the detection width is not limited thereto, and for example, a detection width shorter than the width of the sheet P′ in the main scanning direction may be used.

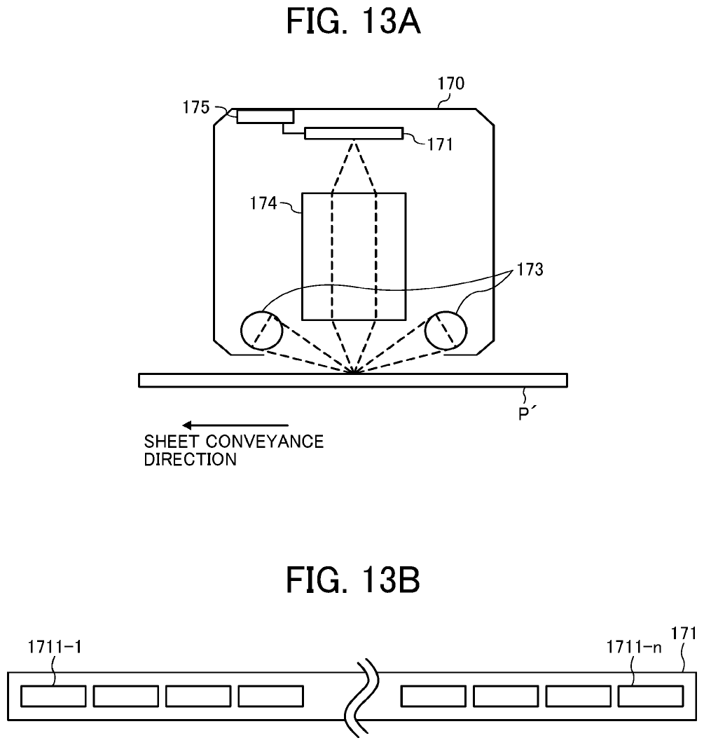

FIG. 13A is a cross-sectional view of the image density sensor 170 taken along a cross section orthogonal to the main scanning direction. As illustrated in FIG. 13A, the image density sensor 170 includes an image element 171, a light source 173, a lens array 174, and an output circuit 175. A broken line represents light emitted from the light source 173.

FIG. 13B is a schematic diagram of a configuration of an image element included in the image density sensor 170. As illustrated in FIG. 13B, the image element 171 has a shape extending in the main scanning direction, and includes small light receiving elements 1711-1 to 1711-n (hereinafter referred to as light receiving elements 1711 unless distinguished from each other) arranged side by side in the main scanning direction. The range in which the light receiving elements 1711 are arranged is the detection width of the image density sensor 170 in the main scanning direction.

As the light source 173, a light source in which a light emitting element is provided at an end portion of a light guide body, an LED array, or the like can be used. The light source 173 emits RGB light. As the lens array 174, for example, a SELFOC (registered trademark) lens is used. The light emitted from the light source 173 is reflected on the sheet P′ and is imaged by the lens array 174. The image element 171 receives the light imaged by the lens array 174 by each light receiving element 1711 illustrated in FIG. 13B, and outputs a signal corresponding to the received light. A complementary metal oxide semiconductor (CMOS) sensor or a charge-coupled device (CCD) sensor, for example, may be used as the image element 171.

The output circuit 175 includes, for example, an application specific integrated circuit (ASIC), and converts the signal from each light receiving element 172 on the image element 171 into data indicating image density corresponding to the position of an image pattern on the sheet P′ and outputs the data. For example, 0 to 255 gradations represented by 8 bits are output.

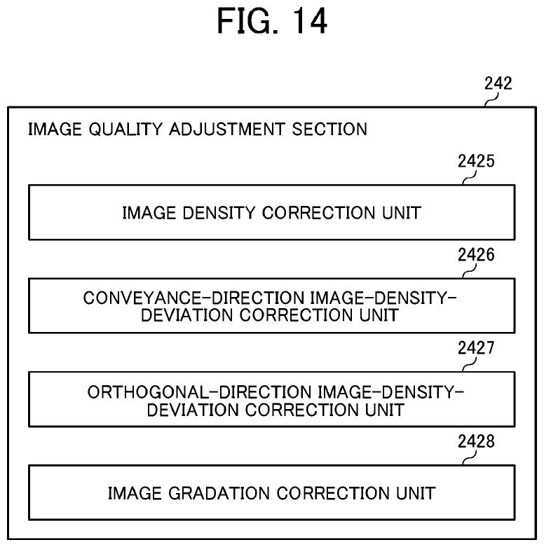

FIG. 14 is a functional block diagram of the image quality adjustment unit 242 in the image quality adjustment control example 2. The image quality adjustment unit 242 of the image quality adjustment control example 2 includes an image density correction unit 2425, a conveyance-direction image-density-deviation correction unit 2426, an orthogonal-direction image-density-deviation correction unit 2427, and an image gradation correction unit 2428. Some or all of these functions can be executed by user instructions from the operation panel 60.

When a difference occurs between the image density target value and the actual image density, the image density correction unit 2425 executes control for correcting the image density difference. Specifically, the image density correction unit 2425 outputs a command for correcting the image density difference to the image formation control unit 241 based on the detection result of an image density correction pattern formed on a sheet P′ detected by the image density sensor 170. Examples of the command for correcting the image density difference include, but are not limited to, a command for adjusting the toner concentration of the developer in the developing device, a command for adjusting the developing bias or the charging bias, a command for adjusting the amount of writing light, a command for changing the secondary transfer bias, a command for changing the fixing temperature, and a command for displaying on the operation panel 60 that the image density deviation occurs.

The conveyance-direction image-density-deviation correction unit 2426 executes control for correcting the image density deviation when the image density deviation of the image formed on the sheet P′ occurs in the conveyance direction of the sheet P, in other words, in the sub-scanning direction. Specifically, the conveyance-direction image-density-deviation correction unit 2426 outputs a command for correcting the image density deviation to the image formation control unit 241 based on the detection result of a conveyance-direction image-density-deviation correction pattern formed on the sheet P detected by the image density sensor 170. Similar to the command for correcting the deviation of the toner adhesion amount in the driving direction in the image quality correction control example 1 described above, examples of the command for correcting the deviation of the image density include, but are not limited to, a command for adjusting the toner concentration of the developer in the developing device, a command for adjusting the developing bias or the charging bias, a command for adjusting the writing light amount, and a command for displaying on the operation panel 60 that a deviation occurs in the image density in the conveyance direction.

The orthogonal-direction image-density-deviation correction unit 2427 executes control for correcting the image density deviation when the image density deviation of the image formed on the sheet P′ occurs in the direction (orthogonal direction) orthogonal to the conveyance direction of the sheet P, in other words, in the main scanning direction. Specifically, the orthogonal-direction image-density-deviation correction unit 2427 outputs a command for correcting the image density deviation to the image formation control unit 241 based on the detection result of an orthogonal-direction image-density-deviation correction pattern formed on the sheet P detected by the image density sensor 170. Similar to the command for correcting the orthogonal-direction toner-adhesion-amount deviation in the image quality correction control example 1 described above, examples of the command for correcting the deviation of the image density include, but are not limited to, a command for adjusting the toner concentration of the developer in the developing device, a command for adjusting the developing bias or the charging bias, a command for adjusting the writing light amount, and a command for displaying on the operation panel 60 that a deviation occurs in the image density in the orthogonal direction.

The image gradation correction unit 2428 executes control for correcting the gradation when an abnormality occurs in the gradation of an image formed on the sheet P′. Specifically, the image gradation correction unit 2428 outputs a command for correcting the gradation to the image formation control unit 241 based on the detection result of an image gradation correction (calibration) pattern formed on the sheet P detected by the image density sensor 170. Similar to the command for the gradation correction in the image quality correction control example 1 described above, examples of the command for correcting the gradation include, but is not limited to, a command for adjusting the toner concentration of the developer in the developing device, a command for adjusting the developing bias or the charging bias, a command for adjusting the writing light amount, and a command for displaying on the operation panel 60 that an abnormality occurs in the gradation.

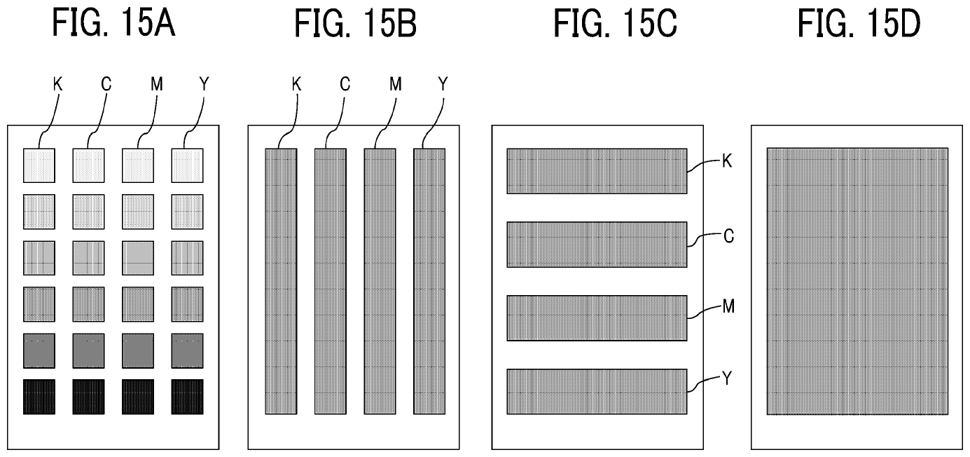

FIGS. 15A to 15D are illustrations of examples of correction patterns formed on a sheet P′, which are used for image quality adjustment controls.

As the image density correction pattern or the image gradation correction pattern, for example, as illustrated in FIG. 15A, a pattern in which gradation patches of K, C, M, and Y are formed in a stepwise manner can be used. FIG. 15A illustrates an example in which the patches of K, C, M, and Y are simultaneously formed with the same gradation. Note that the shape, number, layout, and the like of the formed patches are not limited thereto. For example, the number of output sheets may be two or more. The shape, number, gradation, and layout of patches may be different between the image density correction pattern and the image gradation correction pattern.

As the driving-direction image-density-deviation correction pattern, for example, as illustrated in FIG. 15B, a pattern can be used in which patches of K, C, M, and Y having long shapes in the driving direction are formed. FIG. 15B illustrates an example in which the patches of K, C, M, and Y are simultaneously formed with the same gradation. Note that the shape, number, layout, and the like of the formed patches are not limited thereto. For example, the number of output sheets may be two or more.

As the pattern for correcting the image density deviation in the orthogonal direction, for example, as illustrated in FIG. 15C, a pattern can be used in which patches of K, C, M, and Y having long shapes in the direction (orthogonal direction) orthogonal to the driving direction are formed. FIG. 15C illustrates an example in which the patches of K, C, M, and Y are formed with the same gradation. Note that the shape, number, layout, and the like of the formed patches are not limited thereto. For example, the number of output sheets may be two or more.

Further, the correction of the image density deviation in the driving direction or the correction of the image density deviation in the orthogonal direction can be simultaneously performed using the entire solid image as illustrated in FIG. 15D. In such a case, the entire solid images of K, C, M, and Y with several gradations may be output over a plurality of sheets to calculate the correction values for the respective colors.

The configurations according to the above-descried embodiments are examples, and embodiments of the present disclosure are not limited to the above-described examples. For example, the following aspects can achieve effects described below.

Aspect 1

According to Aspect 1, an image forming apparatus (for example, the image forming apparatus 1) includes an image forming device (for example, the printer engine 100) and a control unit (for example, the execution unit 230) that controls the image forming device. The image forming apparatus includes a selection unit (for example, the selection unit 220) that selects content of control to be executed by the control unit based on a user's selection instruction, and a setting unit (for example, the setting unit 210) that sets a time at which the control unit is caused to execute control of the content selected by the selection unit based on a user's setting instruction. According to this aspect, the image forming apparatus can cause the control unit to execute the control, in which content of control can be selected based on the selection instruction of the user, at the time set based on the setting instruction of the user.

Such a configuration can enhance user convenience compared to a conventional image forming apparatus in which apparatus in which a user cannot select the control content that can be executed by a control unit at the time set by the user.

Aspect 2

According to Aspect 2, in Aspect 1, the image forming apparatus includes a display device (for example, the operation panel 60). After the control unit executes the control of the content selected at the time set by the setting unit, the display device displays at least one of an end time of the executed control, the content of the executed control, and a result of the executed control. According to this aspect, the user can be notified of the end time of the ended control, the content of the executed control, and the result of the executed control. As a result, even if the control operation fails, the user can recognize the fact of the failure and take measures (such as re-execution or calling a service person).

Aspect 3

According to Aspect 3, in Aspect 1 or 2, the control unit executes at least one adjustment control selected by the selection instruction from among a plurality of adjustment controls (for example, adjustments A to D) for adjusting image forming conditions. According to this aspect, the adjustment of the image forming conditions can be performed in a reserved manner, and for example, a fixed adjustment that is performed on a regular basis (for example, in the morning) every day without a user's regular operation. Such a configuration can, for example, bring about a state in which the adjustment is completed immediately after arriving at the office, and thus reduce the downtime of the image forming apparatus.

Aspect 4

According to Aspect 4, in Aspect 3, the plurality of adjustment controls include adjustment control for adjusting the image forming conditions based on an image formed on a recording material. In the adjustment involving the image formation on the recording material, since the recording material owned by the user (asset of the user) is used, automatic execution cannot be performed conventionally. However, in the case in which the adjustment reserved by the instruction operation of the user is performed as in this aspect, the adjustment can be performed such that the recording material which is the asset of the user is consumed.

Aspect 5

According to Aspect 5, the image forming apparatus of FIG. 4 further includes an image density detector (for example, the image density sensor 170) that detects an image density of an image formed on the recording material by the image forming device. The adjustment control includes gradation correction control that performs gradation correction based on a detection result obtained by detecting, with the image density detector, an image density of a gradation correction pattern formed on the recording material. According to this aspect, gradation correction that is frequently performed in the morning or at the start of work on the day can be performed in a reserved manner.

Aspect 6

According to Aspect 6, the image forming apparatus of Aspect 4 or 5 further includes an image density detector configured to detect an image density of an image formed on the recording material by the image forming device. The adjustment control includes image density correction control for performing image density correction based on a detection result obtained by detecting, with the image density detector, an image density of an image density correction pattern formed on the recording material. According to this aspect, the image density correction performed with a high frequency, for example, in the morning or at the start of work on the day can be performed in a reserved manner.

Aspect 7

According to Aspect 7, the image forming apparatus of any one of Aspects 4 to 6 further includes an image density detector to detect an image density of an image formed on the recording material by the image forming device. The adjustment control includes conveyance-direction image-density-deviation correction control to correct an image density deviation in a conveyance direction of the recording material, based on a detection result obtained by detecting, with the image density detector, an image density of a conveyance-direction image-density-deviation correction pattern, which is for correction in the conveyance direction of the recording material, formed on the recording material. According to this aspect, image density deviation correction in the conveyance direction of the recording material, which is frequently executed in the morning or at the start of work on the day, can be performed in a reserved manner.

Aspect 8

According to Aspect 8, the image forming apparatus of any one of Aspects 4 to 7 further includes an image density detector to detect an image density of an image formed on the recording material by the image forming device. The adjustment control includes orthogonal-direction image-density-deviation correction control to correct an image density deviation in an orthogonal direction orthogonal to the conveyance direction of the recording material, based on a detection result obtained by detecting, with the image density detector, an image density of an orthogonal-direction image-density-deviation correction pattern formed on the recording material. According to this aspect, the orthogonal-direction image-density-deviation correction that is frequently executed in the morning or at the start of work on the day can be performed in a reserved manner.

Aspect 9

According to Aspect 9, in any one of Aspects 3 to 8, the image forming device performs image formation by finally transferring a toner image formed on an image bearer (for example, the intermediate transfer belt 130) onto a recording material. The plurality of adjustment controls include adjustment control for adjusting the image forming condition based on the toner image formed on the image bearer. In the adjustment involving the formation of the toner image on the image bearer, since the toner owned by the user (asset of the user) is used, the automatic execution is avoided conventionally. However, in the case in which the adjustment reserved by the instruction operation of the user is performed as in this aspect, the adjustment can be performed such that the toner which is the asset of the user is consumed.

Aspect 10

According to Aspect 10, the image forming apparatus of Aspect 9 further includes a toner adhesion amount detector (for example, the toner adhesion amount sensor 160) that detects a toner adhesion amount of the toner image formed on the image bearer by the image forming device. The adjustment control includes toner adhesion amount control that sets the toner adhesion amount of the toner image formed on the image bearer within a predetermined range. According to this aspect, the toner adhesion amount correction that is frequently performed in the morning or at the start of work on the day can be performed in a reserved manner.

Aspect 11

According to Aspect 11, the image forming apparatus of Aspect 9 or 10 further includes a toner adhesion amount detector to detect a toner adhesion amount of the toner image formed on the image bearer by the image forming device. The adjustment control includes driving-direction toner-adhesion-amount-deviation correction control for correcting the toner adhesion amount deviation in the driving direction of the image bearer, based on a detection result obtained by detecting, with the toner adhesion amount detector, a toner adhesion amount of a driving-direction toner-adhesion-amount-deviation correction pattern formed on the image bearer. According to this aspect, correction of deviation in the toner adhesion amount in the driving direction of the image bearer, which may be frequently performed in the morning or at the start of work on the day, can be performed in a reserved manner.

Aspect 12

According to Aspect 12, in the image forming apparatus of any one of Aspects 9 to 11 further includes a toner adhesion amount detector to detect a toner adhesion amount of the toner image formed on the image bearer by the image forming device. The adjustment control includes orthogonal-direction toner-adhesion-amount-deviation correction control for correcting the toner adhesion amount deviation in am orthogonal direction orthogonal to the driving direction of the image bearer, based on a detection result obtained by detecting, with the toner adhesion amount detector, a toner adhesion amount of an orthogonal-direction toner-adhesion-amount-deviation correction pattern formed on the image bearer. According to this aspect, the toner adhesion amount deviation correction in the perpendicular direction, which is frequently executed in the morning or at the start of the task on the day, can be reserved and executed.

Aspect 13

According to Aspect 13, the image forming apparatus of any one of Aspects 9 to 12 further includes a toner adhesion amount detector to detect a toner adhesion amount of the toner image formed on the image bearer by the image forming device. The adjustment control includes tone correction control for performing tone correction based on a detection result obtained by detecting, with the toner adhesion amount detector, a toner adhesion amount of a tone correction pattern formed on the image bearer. According to this aspect, gradation correction that is frequently performed in the morning or at the start of work on the day can be performed in a reserved manner.

The present disclosure is not limited to specific embodiments described above, and numerous additional modifications and variations are possible in light of the teachings within the technical scope of the present disclosure. It is therefore to be understood that the disclosure of the present specification may be practiced otherwise by those skilled in the art than as specifically described herein. Such modifications and alternatives are within the technical scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An image forming apparatus comprising:
an image forming device; and
control circuitry configured to control the image forming device,
wherein the control circuitry is configured to:
select control content to be executed based on a selection instruction from a user;
set a set time of executing control of the control content selected, based on a setting instruction from the user; and
execute, at the set time, the control of the control content selected.

2. The image forming apparatus according to claim 1, further comprising a display device configured to, after the control circuitry executes the control of the control content selected at the set time, display at least one of an end time of the control executed, a content of the control executed, and a result of the control executed.

3. The image forming apparatus according to claim 1,
wherein the control circuitry is configured to execute at least one adjustment control selected by the selection instruction from among a plurality of adjustment controls for adjusting image forming conditions.

4. The image forming apparatus according to claim 3,
wherein the plurality of adjustment controls include adjustment control for adjusting the image forming conditions based on an image formed on a recording material.

5. The image forming apparatus according to claim 4, further comprising an image density detector configured to detect an image density of an image formed on the recording material by the image forming device,
wherein the adjustment control includes gradation correction control for performing gradation correction based on a detection result obtained by detecting, with the image density detector, an image density of a gradation correction pattern formed on the recording material.

6. The image forming apparatus according to claim 4, further comprising an image density detector configured to detect an image density of an image formed on the recording material by the image forming device,
wherein the adjustment control includes image density correction control for performing image density correction based on a detection result obtained by detecting, with the image density detector, an image density of an image density correction pattern formed on the recording material.

7. The image forming apparatus according to claim 4, further comprising an image density detector configured to detect an image density of an image formed on the recording material by the image forming device,
wherein the adjustment control includes conveyance-direction image-density-deviation correction control to correct an image density deviation in a conveyance direction of the recording material, based on a detection result obtained by detecting, with the image density detector, an image density of an image density deviation correction pattern formed on the recording material.

8. The image forming apparatus according to claim 4, further comprising an image density detector configured to detect an image density of an image formed on the recording material by the image forming device,
wherein the adjustment control includes an orthogonal-direction image-density-deviation correction control configured to correct an image density deviation in an orthogonal direction orthogonal to a conveyance direction of the recording medium, based on a detection result obtained by detecting, with the image density detector, an image density of an image density deviation correction pattern formed on the recording material.

9. The image forming apparatus according to claim 3, further comprising an image bearer,
wherein the image forming device is configured to transfer a toner image formed on the image bearer onto a recording material to perform image formation, and
wherein the plurality of adjustment controls include adjustment control for adjusting the image forming conditions based on the toner image formed on the image bearer.

10. The image forming apparatus according to claim 9, further comprising a toner adhesion amount detector configured to detect a toner adhesion amount of the toner image formed on the image bearer by the image forming device,
wherein the adjustment control includes toner adhesion amount control in which the toner adhesion amount of the toner image formed on the image bearer is adjusted within a predetermined range.

11. The image forming apparatus according to claim 9, further comprising a toner adhesion amount detector configured to detect a toner adhesion amount of the toner image formed on the image bearer by the image forming device,
wherein the adjustment control includes driving-direction toner-adhesion-amount-deviation correction control for correcting a toner adhesion amount deviation in a driving direction of the image bearer, based on a detection result obtained by detecting, with the toner adhesion amount detector, a toner adhesion amount of a toner-adhesion-amount-deviation correction pattern formed on the image bearer.

12. The image forming apparatus according to claim 9, further comprising a toner adhesion amount detector configured to detect a toner adhesion amount of the toner image formed on the image bearer by the image forming device,
wherein the adjustment control includes orthogonal-direction toner-adhesion-amount-deviation correction control for correcting a toner adhesion amount deviation in an orthogonal direction orthogonal to a driving direction of the image bearer, based on a detection result obtained by detecting, with the toner adhesion amount detector, a toner adhesion amount of a toner adhesion amount deviation correction pattern formed on the image bearer.

13. The image forming apparatus according to claim 9, further comprising a toner adhesion amount detector configured to detect a toner adhesion amount of the toner image formed on the image bearer by the image forming device,
wherein the adjustment control includes gradation correction control for performing gradation correction based on a detection result obtained by detecting, with the toner adhesion amount detector, a toner adhesion amount of a tone correction pattern formed on the image bearer.

14. The image forming apparatus according to claim 1,
wherein the control circuitry includes at least one of a central processing unit (CPU), and a read only memory (ROM), and a hard disk drive (HDD).

15. The image forming apparatus according to claim 14,
wherein the CPU is configured to control an operation of the image forming apparatus.

16. The image forming apparatus according to claim 15, further comprising a random access memory (RAM),
wherein the CPU is configured to execute a program stored in the ROM or the HDD and use the RAM as a work area to control the operation of the image forming apparatus.

17. The image forming apparatus according to claim 2,
wherein the control circuitry includes a central processing unit (CPU), and
wherein the CPU is configured to control the display device.

18. The image forming apparatus according to claim 4,
wherein the adjustment control for adjusting the image forming conditions based on the image formed on the recording material is for executing image formation under image forming conditions corresponding to a type of the recording material.

19. The image forming apparatus according to claim 18,
wherein the type of the recording material is configured to be designated by the user.
